(19) United States
(12) Patent Application Publication
(10) Pub. No.: US 2015/0270696 A1
(43) Pub. Date: Sep. 24, 2015

(54) WATERPROOFING STRUCTURE FOR INSULATION-COATED ELECTRICAL WIRE, AND WIRE HARNESS

(71) Applicant: SUMITOMO WIRING SYSTEMS, LTD., Mie (JP)

(72) Inventors: Masataka WAKABAYASHI, Mie (JP); Hiroyuki OOTSUKI, Mie (JP)

(73) Assignee: SUMITOMO WIRING SYSTEMS, LTD., Mie (JP)

(21) Appl. No.: 14/657,168

(22) Filed: Mar. 13, 2015

(30) Foreign Application Priority Data
Mar. 20, 2014 (JP) 2014-058698

(51) Int. Cl. H02G 15/013; H02G 3/04

(52) U.S. Cl. CPC H02G 15/013; H02G 3/0462

(57) ABSTRACT

The present invention relates to a waterproofing structure for an insulation-coated electrical wire that includes a tubular protection member and a resin material that is accommodated in the protection member. An insulation-coated electrical wire passes through the protection member, and the protection member includes a stopper that surrounds one intermediate end of a coating tube that is located on one end side of an exposed conductor section of the insulation-coated electrical wire, and a heat-shrinkable tube that is shrunk to a predetermined shrunk diameter, and closely fits to the stopper on the inner circumference on one end side of the heat-shrinkable tube. The resin material is made of a thermosetting resin that is cured between the protection member and the insulation-coated electrical wire while closely fitting to the stopper, and pair of intermediate ends of the coating tube on both ends of the exposed conductor section.

### TECHNICAL FIELD

The present invention relates to a waterproofing structure for an insulation-coated electrical wire, and a wire harness, and in particular to a waterproofing structure for an insulation-coated electrical wire that is effectively provided in an intermediate section of the insulation-coated electrical wire, and a wire harness.

### BACKGROUND ART

In a wire harness that is mounted in an automobile and the like, it is often the case that a coating of an insulation-coated electrical wire is partially removed to expose a conductor constituted by a group of bare wires, and another electrical wire is connected to the exposed conductor section using resistance welding or a crimping terminal, or a connection terminal is crimped to the exposed conductor section. Such an exposed conductor section or an electrical connection section needs reliable waterproofing when it is to be arranged in an area that is exposed to water.

Conventionally, therefore, a waterproofing structure (see, for example, JP 2006-81319A) has been proposed in which a terminal splice section that connects exposed conductor sections formed at terminal ends of a plurality of electrical wires is housed in an heat-shrinkable tube whose one end is closed, and the terminal splice section is then immersed in a flowable thermosetting waterproofing gent that is injected into the heat-shrinkable tube, and the thermosetting waterproofing agent is heated and cured in the state in which the terminal splice section is immersed therein.

Furthermore, a waterproofing structure (see, for example, JP 2009-129589A) has also been proposed in which an intermediate splice section is formed by connecting an exposed conductor section at a terminal end of one insulation-coated electrical wire to an exposed conductor section at an intermediate position of another electrical wire, and after one end of a heat-shrinkable tube in which the splice section is housed is thermally shrunk so as to closely fit to the insulation-coated electrical wire, a solid powder thermosetting waterproofing agent is injected into the heat-shrinkable tube and cured.

JP 2006-81319A and JP 2009-129589A are examples of related art.

### SUMMARY OF THE INVENTION

However, the former conventional waterproofing structure for an insulation-coated electrical wire in which the terminal splice section is accommodated in a heat-shrinkable tube whose one end is closed cannot be adopted with an insulation-coated electrical wire in which an intermediate splice is formed.

On the other hand, the latter conventional waterproofing structure for an insulation-coated electrical wire in which an intermediate splice section is waterproofed can be adapted to the case where an intermediate splice is formed, but there is the following problem that has not been solved.

That is, in the latter conventional waterproofing structure for an insulation-coated electrical wire, when the shrunk diameter of the heat-shrinkable tube is set to be small in order to improve the adhesion between one end of the heat-shrinkable tube that is to be shrunk before the injection of the waterproofing agent and the insulation-coated electrical wire, this may, in cases such as where a connection terminal is mounted in advance to an end of the insulation-coated electrical wire, cause deterioration in workability of the operation of inserting the insulation-coated electrical wire through the heat-shrinkable tube, and thus an increase in cost. Furthermore, there is concern that when the shrunk diameter of one end of the heat-shrinkable tube that is to be shrunk before the injection of the waterproofing agent is overly small, it may be difficult for the waterproofing agent to penetrate into gaps formed between adjacent bare wires between the insulation-coating tube and the exposed conductor section. Therefore, a higher waterproofing performance has been desired in order to prevent secondary water exposure that is caused by a capillary action and the like from the water exposed area at an intermediate section of a single insulation-coated electrical wire.

The present invention was made in order to solve the above-described problem, and it is an object of the present invention to provide a low-cost waterproofing structure for an insulation-coated electrical wire that can ensure a high waterproofing performance and excellent workability, and a low-cost wire harness that has a high waterproofing performance and an excellent workability.

In order to achieve the above-described object, a waterproofing structure for an insulation-coated electrical wire according to the present invention includes: a tubular protection member in which an exposed conductor section formed in a part in the longitudinal direction of the insulation-coated electrical wire is accommodated together with ends of a coating tube of the insulation-coated electrical wire that are adjacent to the exposed conductor section; and a resin material that is accommodated in the protection member and cured into a tubular shape in a state of covering the exposed conductor section and the ends of the coating tube that are adjacent to the exposed conductor section, wherein the insulation-coated electrical wire passes through the protection member, the protection member includes a stopper that surrounds an end of the coating tube that is located on one end side of the exposed conductor section, and a heat-shrinkable tube that is shrunk to a predetermined shrunk diameter and to closely fit to the stopper, on the inner circumference on one end side of the heat-shrinkable tube, and the resin material is made of a thermosetting resin that is cured, between the protection member and the insulation-coated electrical wire, while closely fitting to the stopper and the pair of ends of the coating tube on both end sides of the exposed conductor section.

With this configuration, it is possible to reliably ensure an appropriate degree of adhesion between the stopper and the end of the coating tube of the insulation-coated electrical wire, while ensuring sufficient adhesion, with respect to the stopper, of one end of the heat-shrinkable tube that is to be shrunk before injection of a waterproofing agent. It is also possible to easily set the inner diameter of the heat-shrinkable tube so as to be suitable for the operation of inserting the electrical wire into the heat-shrinkable tube. Accordingly, it is possible to realize a waterproofing structure for an insulation-coated electrical wire that has a high waterproofing performance in which the resin material penetrates into gaps in the ends of the coating tube, while achieving a reduction in cost by simplification of the operation for inserting the electrical wire into the heat-shrinkable tube.

According to the waterproofing structure for an insulation-coated electrical wire of the present invention, it is preferable that the resin material is made from a layer of a cured thermosetting epoxy resin of a two-component mixture.

With this configuration, a low-viscosity thermosetting epoxy resin of a two-component mixture can be used that has a high adhesion to the circumference of the exposed conductor section and easily penetrates into gaps in the ends of the coating tube before being thermally cured. Therefore, it is possible to configure a resin material that is cured in the state of closely fitting to the circumference of the exposed conductor section and penetrating into gaps in the ends of the coating tube, and that has a high waterproofing performance and a reliable heat resistance.

A wire harness according to the present invention includes the above-described waterproofing structure for an insulation-coated electrical wire. With this configuration, a low-cost wire harness that has a high waterproofing performance and an excellent workability is obtained.

According to the present invention, it is possible to provide a low-cost waterproofing structure for an insulation-coated electrical wire that can ensure a high waterproofing performance and an excellent workability, and a low-cost wire harness that has a high waterproofing performance and an excellent workability.

### BRIEF DESCRIPTION OF THE DRAWINGS

FIG. 1 is an illustrative diagram of a heating stage after a waterproofing agent is injected, showing cross-sectional views of states before and after heat-curing of a resin member and heat shrinkage of a heat-shrinkable tube in a waterproofing structure for an insulation-coated electrical wire according to a first embodiment of the present invention.

FIG. 2 is an illustrative diagram of a process of an example of a stage before the injection of a waterproofing agent, showing cross-sectional views of states before and after one end of the heat-shrinkable tube is thermally shrunk so as to closely fit to a stopper, in the waterproofing structure for an insulation-coated electrical wire according to the first embodiment of the present invention.

FIG. 3 is an illustrative diagram of a process of a modification of the stage before the injection of a waterproofing agent, showing cross-sectional views of states before and after one end of the heat-shrinkable tube is thermally shrunk so as to closely fit to the stopper, in the waterproofing structure for an insulation-coated electrical wire according to the first embodiment of the present invention.

FIG. 4(a) is a plan view showing the stopper of the waterproofing structure for an insulation-coated electrical wire according to the first embodiment of the present invention.

FIG. 4(b) is a cross-sectional view taken along the arrow B-B of FIG. 4(a).

FIG. 5 is an illustrative diagram of a heating stage after the injection of the waterproofing agent, showing cross-sectional views of states before and after heat-curing of a resin member and heat shrinkage of a heat-shrinkable tube in a waterproofing structure for an insulation-coated electrical wire according to a second embodiment of the present invention.

FIG. 6 is an illustrative diagram of a process of an example of the step before the injection of a waterproofing agent, showing cross-sectional views of states before and after one end of the heat-shrinkable tube is thermally shrunk so as to closely fit to the stopper, in the waterproofing structure for an insulation-coated electrical wire according to the second embodiment of the present invention.

FIG. 7 illustrates a process of a modification of the step before the injection of a waterproofing agent, showing cross-sectional views of states before and after one end of the heat-shrinkable tube is thermally shrunk so as to closely fit to the stopper in cross-sectional views, in the waterproofing structure for an insulation-coated electrical wire according to the second embodiment of the present invention.

### EMBODIMENTS OF THE INVENTION

Hereinafter, embodiments for implementing the present invention will be described.

### First Embodiment

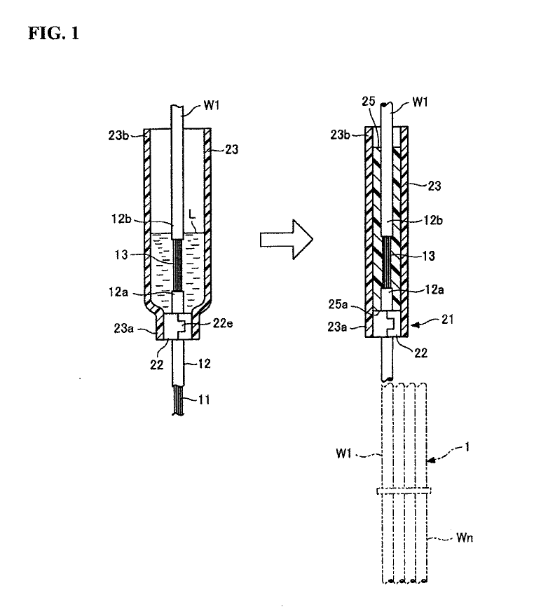

FIGS. 1 to 4 show a first embodiment of a wire harness having a waterproofing structure for an insulation-coated electrical wire according to the present invention. In this embodiment, the waterproofing structure for an insulation-coated electrical wire of the present invention is applied to a single vehicle wire harness that has a waterproofing structure.

First, the configuration of the present embodiment will be described.

As shown in FIG. 1, in a wire harness 1 that includes a plurality of insulation-coated electrical wires W1 to Wn (n is a natural number that is 2 or more) forming a bundle of electrical wires, the insulation-coated electrical wire W1 has the waterproofing structure for an insulation-coated electrical wire according to the present embodiment.

The insulation-coated electrical wire W1 is constituted by a conductor 11 in which, for example, a plurality of bare wires are bundled, and a coating tube 12 that surrounds the conductor 11 concentrically.

The conductor 11 is constituted by a circular stranded wire obtained by twisting together a plurality of bare wires that are soft conducting wires, but may also be a single conducting wire. Furthermore, the coating tube 12 is made of a coating tube that is formed of a resin made mainly of a vinyl chloride resin for example, and has a circular cross section.

In an intermediate section (that is distanced away from both ends) in the length direction of the insulation-coated electrical wire W1, an exposed conductor section 13 is provided that is obtained by stripping and removing an intermediate section of the coating tube 12 within a predetermined length range, and exposing a part of the conductor 11 outwardly of the coating tube 12.

The exposed conductor section 13, together with intermediate ends 12a and 12b of the coating tube 12 that are adjacent to both ends of the exposed conductor section 13, is accommodated in a substantially cylindrical protection member 21 for insulation, heat resistance, and mechanical protection.

Furthermore, in the protection member 21, a resin material 25 is provided that serves as a waterproofing agent, and is cured into a substantially cylindrical shape in the state of covering the exposed conductor section 13, and the intermediate ends 12a and 12b of the coating tube 12 that are adjacent to the exposed conductor section 13.

This resin material 25 has an outer diameter that is larger than that of the coating tube 12, and a length in the axial direction that is larger than that of the exposed conductor section 13. Furthermore, the protection member 21 has an outer diameter and a length in the axial direction that both are larger than those of the resin material 25. Furthermore, the insulation-coated electrical wire W1 passes through the tubular protection member 21 in the direction of the central axis.

On the other hand, the protection member 21 includes a stopper 22, which surrounds one intermediate end 12a of the coating tube 12 that is located on one end side of the exposed conductor section 13, and a heat-shrinkable tube 23 that is shrunk to a predetermined shrunk diameter and closely fits to the stopper 22, on the inner circumference on one end side of the heat-shrinkable tube 23. “Heat-shrinkable tube” refers to a tube that is shrunk by heat in a radial direction, and is manufactured by cutting an elongated tube.

Furthermore, the resin material 25 is made of a thermosetting resin that is cured between the protection member 21 and the insulation-coated electrical wire W1, while closely fitting to the stopper 22, and the intermediate ends 12a and 12b of the coating tube 12 that are on both end sides of the exposed conductor section 13.

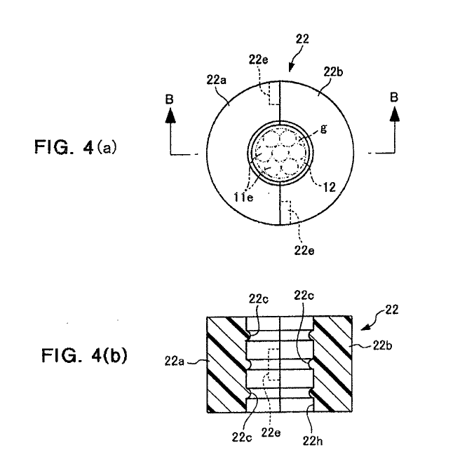

Specifically, as shown in FIGS. 4(a) and 4(b), the stopper 22 is made of a circular member that is obtained by combining a pair of arc-like stopper members 22a and 22b together via recessed and raised engagement sections 22e. The stopper 22 includes, on the inner circumferential surface 22h thereof, a plurality of circular ribs 22c that are separated from each other in the axial direction. The inner diameter of the plurality of circular ribs 22c is slightly smaller than the outer diameter of the coating tube 12, and thus the stopper 22 closely fits to the outer circumference of the coating tube 12 with a predetermined margin.

Furthermore, the stopper 22 is made of a polyolefin system resin, such as polypropylene (PP) or polyethylene (PE).

The heat-shrinkable tube 23 is made of a polyolefin system resin, such as polypropylene (PP) or polyethylene (PE), that can closely fit to the outer circumference of the stopper 22 by heat shrinkage and advantageously has heat-sealing characteristics. This heat-shrinkable tube 23 is a well-known heat-shrinkable tube that is shrunk to a predetermined shrunk diameter so as to have an inner diameter after heat shrinkage that is approximately half as small as that before heat shrinkage.

The resin material 25 is made from a layer obtained by thermally curing a low-viscosity thermosetting epoxy resin of a two-component mixture. “Low-viscosity” means a viscosity to the extent that a flowable thermosetting epoxy resin of a two-component mixture before being heated and cured has a high adhesion to the circumference of the exposed conductor section 13, and easily penetrates into gaps in the intermediate ends 12a and 12b of the coating tube 12.

This resin material 25 is cured while forming, between the protection member 21 and the insulation-coated electrical wire W1, one end face 25a that closely fits to the stopper 22, and penetrates into the gaps in the intermediate ends 12a and 12b that are formed between the exposed conductor section 13 and the corresponding one of the pair of the intermediate ends 12a and 12b of the coating tube 12 on both end sides of the exposed conductor section 13.

The gaps in the intermediate ends 12a and 12b of the coating tube 12 are gaps formed between the exposed conductor section 13, and the corresponding one of the pair of the intermediate ends 12a and 12b of the coating tube 12 on both end sides of the exposed conductor section 13, and at least include gaps g (see FIG. 4(a)) that are formed between the adjacent bare wires 11e near the inner circumferences of the intermediate ends 12a and 12b of the coating tube 12, and may also include gaps within the exposed conductor section 13.

The following will describe an example of a method for manufacturing the wire harness 1 of the present embodiment.

First, as a preparatory stage, a connection terminal 14 for electrical connection is crimped to an end of at least the insulation-coated electrical wire W1, and then the exposed conductor section 13 is formed at an intermediate section of the insulation-coated electrical wire W1.

Then, the respective recessed and raised surfaces of the pair of arc-like stopper members 22a and 22b are engaged together, with the one intermediate end 12a of the coating tube 12 sandwiched therebetween, the one intermediate end 12a being located on one end side of the exposed conductor section 13 of the insulation-coated electrical wire W1 that has been subjected to the preparation step, and the stopper 22 is mounted on the insulation-coated electrical wire W1 so that the end face of the stopper 22 is located at a predetermined distance dp from an end of the exposed conductor section 13. The predetermined distance dp is not particularly limited, and may be, for example, the diameter of the exposed conductor section 13 or more.

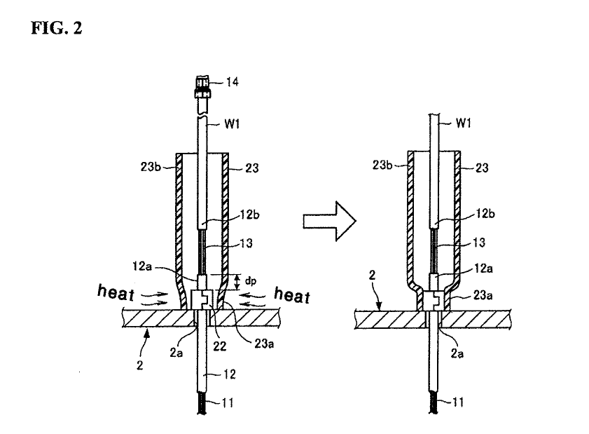

Then, as shown on the left side of FIG. 2, the insulation-coated electrical wire W1 on which the stopper 22 is mounted is inserted into the heat-shrinkable tube 23, and is set in a jig 2 that has a substantially U-shaped groove 2a with a width smaller than the diameter of the stopper 22. Then, as shown on the right side of FIG. 2, the one end 23a of the heat-shrinkable tube 23 that surrounds the stopper 22 is heated with hot air or the like so that the inner circumference of the one end of the heat-shrinkable tube 23 closely fits to the outer circumference of the stopper 22, and the heat-shrinkable tube 23 is closed and sealed against fluids.

Then, as shown on the left side of FIG. 1, a thermosetting epoxy resin L (hereinafter, referred to as a waterproofing agent) of a two-component mixture is injected into the heat-shrinkable tube 23, and then the entire heat-shrinkable tube 23 is externally heated and shrunk so that the thermosetting epoxy resin L in the heat-shrinkable tube 23 is cured. At that time, first, the entire heat-shrinkable tube 23 is thermally shrunk so that its diameter is greatly reduced, and the fluid level of the thermosetting epoxy resin L rises. Then, the heat-shrinkable tube 23 is entirely shrunk to the extent that its diameter is close to a predetermined shrunk diameter, and the thermosetting epoxy resin L starts to thermally cure. As a result, the heat-shrinkable tube 23 is entirely shrunk to the extent that its diameter is the predetermined shrunk diameter, and the resin material 25 made from a layer of the cured thermosetting epoxy resin is formed.

Note that in FIG. 1, the heat-shrinkable tube 23 in the step in which heat shrinkage of the heat-shrinkable tube 23 and thermal curing of the thermosetting epoxy resin are completed is shown in the shape of a substantially straight cylinder. However, a configuration is also possible in which a thermosetting epoxy resin that can cure quickly is used so that the entire diameter of the heat-shrinkable tube 23 is greatly reduced with respect to that before the shrinkage but so that the outer diameter of the other end 23b is slightly larger than the outer diameter of the one end 23a.

The following will describe the effects of the present embodiment.

According to the waterproofing structure for an insulation-coated electrical wire of the present embodiment configured as described above, it is possible to reliably ensure an appropriate degree of adhesion between the stopper 22 and the one intermediate end 12a of the coating tube 12 for the insulation-coated electrical wire W1, while ensuring sufficient adhesion of the one end 23a of the heat-shrinkable tube 23 that is to be shrunk before injection of a waterproofing agent with respect to the stopper 22. It is also possible to easily set the inner diameter of the heat-shrinkable tube 23 so as to be suitable for the operation of inserting the insulation-coated electrical wire W1 into the heat-shrinkable tube 23.

Accordingly, it is possible to realize a waterproofing structure for the insulation-coated electrical wire W1 that has a high waterproofing performance in which the resin material 25 penetrates into gaps g and the like in the intermediate ends 12a and 12b of the coating tube 12, while achieving a reduction in cost by simplification of the operation for inserting the electrical wire into the heat-shrinkable tube 23.

Furthermore, in the present embodiment, the thermosetting epoxy resin of a two-component mixture that serves as the resin material 25 may also be a low-viscosity thermosetting epoxy resin of a two-component mixture that has a high adhesion to the circumference of the exposed conductor section 13 and easily penetrates into the intermediate ends 12a and 12b of the coating tube 12 before being thermally cured. Therefore, it is possible to configure the resin material 25 having a high waterproofing performance and a reliable heat resistance, the resin material 25 being cured in the state of closely fitting to the circumference of the exposed conductor section 13 and penetrating into the gaps g in the intermediate ends 12a and 12b of the coating tube 12. Therefore, it is possible to achieve a high waterproofing performance.

Furthermore, in the present embodiment, the waterproofing structure section also has an excellent outer appearance since the one end 23a of the heat-shrinkable tube 23 closely fits to the circumference of the stopper 22, and the diameter of the remaining section of the heat-shrinkable tube 23 is reduced to a predetermined shrunk diameter that is close to that of the one end 23a.

The wire harness 1 according to the present embodiment has the waterproofing structure for the insulation-coated electrical wire W1 that has the above-described configuration, and thus is a low-cost wire harness having a high waterproofing performance and an excellent workability.

Accordingly, in the present embodiment, it is possible to provide a low-cost waterproofing structure for an insulation-coated electrical wire that can ensure a high waterproofing performance and an excellent workability, and a low-cost wire harness 1 that has a high waterproofing performance and an excellent workability.

Modification of Manufacturing Method

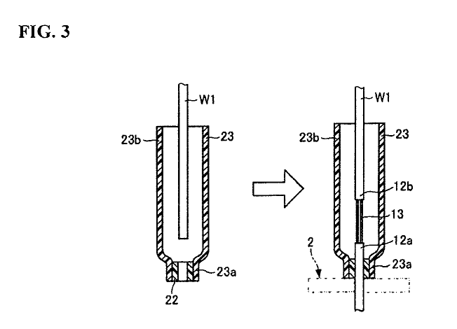

The step for mounting the stopper 22 on the insulation-coated electrical wire W1 that has been subjected to the preparation step in the foregoing example of the manufacturing method, and the step for heating the one end 23a of the heat-shrinkable tube 23 so that it closely fits to the outer circumference of the stopper 22 may also be executed in different procedures such as a modified example of the manufacturing method shown in FIG. 3.

That is, first, as shown on the left side of FIG. 3, the one end 23a of the heat-shrinkable tube 23 is heated with hot air or the like so that the inner circumference of the one end 23a of the heat-shrinkable tube 23 closely fits to the outer circumference of the stopper 22. Then, the insulation-coated electrical wire W1 that has been subjected to the preparation step is inserted into the stopper 22 so as to pass through from the center of the heat-shrinkable tube 23 in the axial direction. In this case, in order to simplify the insertion of the insulation-coated electrical wire W1, the stopper 22 may be made elastic, an adhesive agent layer may be provided between the coating tube 12 and the stopper 22, or the diameter of the stopper 22 may slightly be reduced by heating until the thermal shrinkage of the heat-shrinkable tube 23 and thermal curing of the thermosetting epoxy resin are completed.

### Second Embodiment

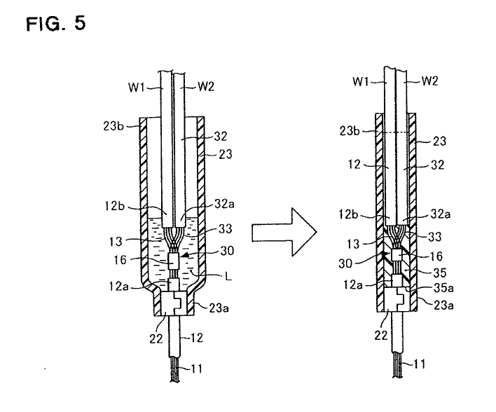

FIGS. 5 to 7 show a second embodiment of the wire harness according to the present invention.

In this embodiment, the waterproofing structure for an insulation-coated electrical wire according to the present invention is applied to a vehicle wire harness that has an intermediate splice section. Note that the present embodiment differs from the foregoing first embodiment in the configuration of the intermediate exposed conductor section of the insulation-coated electrical wire, but that the remaining configuration of the present embodiment is the same as or similar to that of the first embodiment. Accordingly, the reference numerals corresponding to the components shown in FIGS. 1 to 4 are used for the configurations that are the same as or similar to that of the first embodiment, and the difference between the present embodiment and the first embodiment will be described below.

As shown in FIG. 5, a waterproofing structure for an insulation-coated electrical wire according to the present embodiment is such that an exposed conductor section 13 is formed by partially stripping the coating tube 12 at an intermediate section of the first insulation-coated electrical wire W1, and an exposed conductor section 33, which is a terminal lead wire of a second insulation-coated electrical wire W2, is connected to the that exposed conductor section 13 via a crimped member 16, thus forming an intermediate splice section 30.

This intermediate splice section 30 is accommodated in the protection member 21, together with the intermediate ends 12a and 12b of the coating tube 12 that are adjacent to both end sides of the intermediate splice section 30.

Furthermore, a resin material 35, which serves as a waterproofing agent, is provided in the protection member 21. This resin material 35 is cured in the state of covering the intermediate splice section 30, the intermediate ends 12a and 12b of the coating tube 12 of the first insulation-coated electrical wire W1 that are adjacent to the intermediate splice section 30 on both end sides thereof, and an end 32a of a coating tube 32 of the second insulation-coated electrical wire W2.

The resin material 35 has a diameter that is larger than the sum of the outer diameters of the coating tubes 12 and 32, and has a length in the axial direction that is larger than the lengths of the exposed conductor section 13 and the intermediate splice section 30. Furthermore, the protection member 21 has an outer diameter and a length in the axial direction that are both larger than those of the resin material 35. Furthermore, the insulation-coated electrical wire W1 passes through the tubular protection member 21 in the central axis direction.

Similarly to the first embodiment, the protection member 21 includes the stopper 22 and the heat-shrinkable tube 23. Furthermore, the resin material 35 is cured between the protection member 21 and the first and second insulation-coated electrical wires W1 and W2, while closely fitting to the stopper 22, the intermediate ends 12a and 12b of the coating tube 12, and the end 32a of the coating tube 32, the ends 12a , 12b , and 32a being adjacent to the exposed conductor sections 13 and 33.

Similarly to the resin material 25 of the first embodiment, the resin material 35 is made from a layer obtained by thermally curing a low-viscosity thermosetting epoxy resin of a two-component mixture. With this, the resin material 35 is cured between the protection member 21 and the first and second insulation-coated electrical wires W1 and W2, while forming one end face 35a that closely fits to the stopper 22, and penetrating into gaps g and the like that are formed between the exposed conductor section 13 and the intermediate end 12a and between the exposed conductor section 13 and the intermediate end 12b and the end 32a.

When the wire harness 1 of the present embodiment is manufactured, as a preparation step, connection terminals 14 or the like for electrical connection are crimped to ends of at least the first and second insulation-coated electrical wires W1 and W2. Then, the exposed conductor section 13 is formed in an intermediate section of the first insulation-coated electrical wire W1, the exposed conductor section 33 is formed at an end of the second insulation-coated electrical wire W2, and the intermediate splice section 30 is formed by crimping and connecting the exposed conductor sections 13 and 33 to each other by the crimped member 16.

Then, the stopper 22 is mounted on one intermediate end 12a of the coating tube 12 that is located on one end side of the exposed conductor sections 13 of the first and second insulation-coated electrical wires W1 and W2 that has been subjected to the preparation step, so that the end face of the stopper 22 is located at a predetermined distance dp from one end of the exposed conductor section 13.

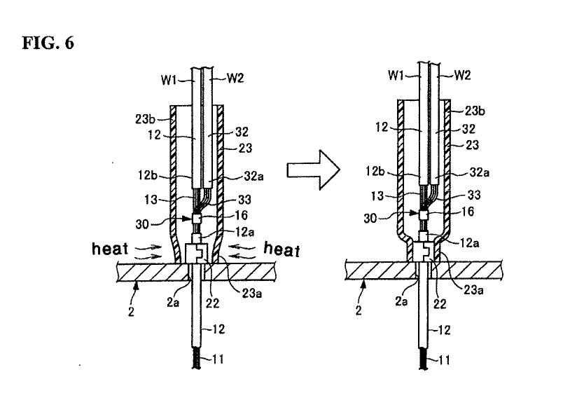

Then, as shown on the left side of FIG. 6, the first and second insulation-coated electrical wires W1 and W2 are set in the jig 2 and the one end 23a of the heat-shrinkable tube 23 is heated, and as shown on the right side of FIG. 6, the inner circumference of the one end of the heat-shrinkable tube 23 closely fits to the outer circumference of the stopper 22, and the heat-shrinkable tube 23 is closed and sealed against fluid.

Then, as shown on the left side of FIG. 5, a low-viscosity thermosetting epoxy resin L of a two-component mixture is injected into the heat-shrinkable tube 23, and the entire heat-shrinkable tube 23 is externally heated and shrunk, and the thermosetting epoxy resin L in the heat-shrinkable tube 23 is cured. With this, first, the heat-shrinkable tube 23 is thermally shrunk so that the entire diameter is greatly reduced and the fluid level of the thermosetting epoxy resin L rises. Then, the heat-shrinkable tube 23 is entirely shrunk to the extent that its diameter is close to a predetermined shrunk diameter, and the thermosetting epoxy resin L starts to thermally cure. As a result, the heat-shrinkable tube 23 is shrunk to the extent to the extent that its diameter is the predetermined shrunk diameter, and the resin material 35 made from a layer of the cured thermosetting epoxy resin is formed.

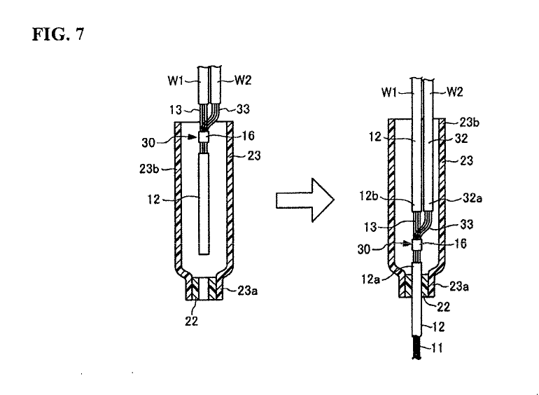

Note that in the present embodiment as well, the process for mounting the stopper 22 on the insulation-coated electrical wire W1, and the process for heating the one end 23a of the heat-shrinkable tube 23 so that it closely fits to the outer circumference of the stopper 22 may also be executed in different procedures such as a modified example of the manufacturing method shown in FIG. 7.

That is, first, as shown on the left side of FIG. 7, the one end 23a of the heat-shrinkable tube 23 is heated with hot air or the like so as to closely fit to the outer circumference of the stopper 22. Then, the first and second insulation-coated electrical wires W1 and W2 are inserted into the stopper 22, and the top end of the first insulation-coated electrical wire W1 is passed through the center of the heat-shrinkable tube 23.

In the present embodiment as well, it is possible to achieve a waterproofing structure having a high waterproofing performance in which the resin material 35 penetrates into the gaps g and the like of the ends 12a , 12b , and 32a of the coating tubes 12 and 32, while achieving a reduction in cost by simplification of the operation for inserting the electrical wire into the heat-shrinkable tube 23.

Furthermore, a low-viscosity thermosetting epoxy resin liquid can be used that has a high adhesion to the circumferences of the exposed conductor sections 13 and 33 and easily penetrates into the gaps g and the like of the intermediate ends 12a and 12b and the end 32a of the coating tubes 12 and 32, and thus a resin material 35 that has a high waterproofing performance and a reliable high heat resistance can be configured.

Therefore, according to the present embodiment as well, it is possible to provide a low-cost waterproofing structure for an insulation-coated electrical wire that can ensure a high waterproofing performance and an excellent workability, and a low-cost wire harness 1 that has a high waterproofing performance and an excellent workability.

Note that in the foregoing embodiments, the stopper 22 is circular-shaped through which one electrical wire is inserted, but may also have a plurality of through-holes through which a plurality of electrical wires are inserted. In this case, it is also conceivable that, for example, exposed conductor sections 13 of the plurality of insulation-coated electrical wires are formed at positions that are shifted in the axial direction, and thereby the exposed conductor sections 13 of the plurality of insulation-coated electrical wires, intermediate splice sections 30 and the like are accommodated in the heat-shrinkable tube 23.

As described above, the present invention can provide a low-cost waterproofing structure for an insulation-coated electrical wire and a wire harness having this structure that can ensure a high waterproofing performance and an excellent workability, and is useful in a waterproofing structure for an insulation-coated electrical wire that is effectively provided at an intermediate section of the insulation-coated electrical wire, and in wire harnesses in general.

### LIST OF REFERENCE NUMERALS

1 Wire harness
11 Conductor
12, 32 Coating tube
12a, 12b Intermediate end (end)
13, 33 Exposed conductor section
Protection member
Stopper
Heat-shrinkable tube
23a One end
25, 35 Resin material
Intermediate splice section
32a End
W1 Insulation-coated electrical wire (first insulation-coated electrical wire)
W2 Second insulation-coated electrical wire

What is claimed is:

1. A waterproofing structure for an insulation-coated electrical wire comprising:
a tubular protection member in which an exposed conductor section formed in a portion in the longitudinal direction of the insulation-coated electrical wire is accommodated together with ends of a coating tube of the insulation-coated electrical wire that are adjacent to the exposed conductor section; and
a resin material that is accommodated in the protection member and cured into a tubular shape while covering the exposed conductor section and the ends of the coating tube that are adjacent to the exposed conductor section,
wherein the insulation-coated electrical wire passes through the protection member,
the protection member including a stopper that surrounds an end of the coating tube that is located on one end side of the exposed conductor section, and a heat-shrinkable tube that is shrunk to a predetermined shrunk diameter and closely fit to the stopper, on the inner circumference of one end side of the heat-shrinkable tube, and
the resin material is made of a thermosetting resin that is cured, between the protection member and the insulation-coated electrical wire, while closely contacting the stopper and the pair of ends of the coating tube on both end sides of the exposed conductor section.

2. The waterproofing structure for an insulation-coated electrical wire according to claim 1,
wherein the resin material is made from a layer of a cured thermosetting epoxy resin of a two-component mixture.

3. A wire harness comprising the waterproofing structure for an insulation-coated electrical wire according to claim 1.

4. A wire harness comprising the waterproofing structure for an insulation-coated electrical wire according to claim 2.
